(19) United States
(12) Patent Application Publication
(10) Pub. No.: US 2026/0087180 A1
(43) Pub. Date: Mar. 26, 2026

(54) SECURITY MODULE VALIDATION

(71) Applicant: Hewlett Packard Enterprise Development LP, Spring, TX (US)

(72) Inventors: Dilip Kumar Ramakrishna Reddy, Bangalore (IN); Shiva R. Dasari, Spring, TX (US); Kenneth John Geer, Aurburn, CA (US); Stephen Barnett Lyle, Granite Bay, CA (US)

(21) Appl. No.: 18/918,507

(22) Filed: Oct. 17, 2024

(30) Foreign Application Priority Data
Aug. 8, 2024 (IN) 202411060007

(51) Int. Cl. G06F 21/72; G06F 21/60; G06F 21/73

(52) U.S. Cl. CPC G06F 21/72; G06F 21/602; G06F 21/73

(57) ABSTRACT

In some examples, a system can validate a security module connected to a processor module using a cryptographic device identity of the security module, and perform a manifest certificate check based on a manifest certificate containing information representing a security processor in the security module.

### BACKGROUND

A computing environment can include various resources to perform respective tasks. An example of a computing environment is a data center operated by an enterprise. Users of the enterprise are able to access resources of the data center. Another example of a computing environment is a cloud computing environment with resources accessible over a network by users of the cloud computing environment.

### BRIEF DESCRIPTION OF THE DRAWINGS

Some implementations of the present disclosure are described with respect to the following figures.

FIG. 1 is a block diagram of an arrangement including a security module, a host processor module, and a management system, according to some examples.

FIG. 2 is a flow diagram of a validation procedure according to some examples.

FIG. 3 is a block diagram of a storage medium storing machine-readable instructions according to some examples.

FIG. 4 is a flow diagram of a process according to some examples.

FIG. 5 is a block diagram of a management system according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A modular arrangement of resources in a computing environment can include electronic modules that perform respective tasks. In some examples, the electronic modules can include host processor modules (HPMs) and security control modules (SCMs). A HPM can include a host central processing unit (CPU) and memory, such as the host CPU and memory of a computer server or another type of electronic device. A SCM can include a management controller and a security subsystem. An example of a management controller that performs management tasks is a baseboard management controller (BMC). An example of a security subsystem is a secure element with a security processor, such as a Trusted Platform Module (TPM), to perform security tasks. Note that there may be other examples of electronic modules in a modular arrangement of resources.

By using HPMs and SCMs, host processing functionalities (in a HPM) and management and security functionalities (in a SCM) can be separated into different modules. A modular arrangement allows HPMs of different form factors to be developed, and a SCM may be interconnected to a HPM of any of the different form factors. In some examples, a modular arrangement of resources can be according to a Data Center Modular Hardware System (DC-MHS) specification provided by the Open Compute Project (OCP). In other examples, modular arrangements of resources in a computing environment can be according to other protocols, which can be standardized protocols, open-source protocols, or proprietary protocols.

OCP allows a SCM to be physically connected to any of various different HPMs (including HPMs of different form factors). Also, a SCM can be disconnected from a HPM and connected to another HPM. The ability to removably connect SCMs and HPMs raises security issues. A SCM stores a cryptographic device identity that is used to authenticate the SCM. In a security risk scenario, a first SCM may be disconnected from a first HPM and connected to a second HPM. A second SCM previously connected to the second HPM may have been disconnected from the second HPM to perform the SCM swap. The first HPM may be located in an unsecure area, while the second HPM may be located in a secure area. The first SCM provided for use with the first HPM (located in the unsecure area) may be used to perform unauthorized access of the second HPM (located in the secure area), since the second HPM would authenticate the first SCM based on the cryptographic device identity in the first SCM. In this way, an attacker can use the first SCM originally provisioned for use in the unsecure area to gain access to the secure area. More generally, unauthorized access to a given HPM may be possible by swapping a SCM at the given HPM so that an attacker is provided with privileges and access that may not be intended. Because the cryptographic device identity stored in the SCM travels with the SCM, a HPM to which the SCM is connected would not be able to detect that the SCM should not be connected to the HPM. Once a SCM swap has occurred, an attacker can perform unauthorized access of information and resources, and can cause damage in a computing environment by introducing malware or performing other malicious actions. This type of attack is referred to as an identity manipulation attack.

In accordance with some implementations of the present disclosure, to address identity manipulation attacks, a management system is able to determine whether a security module (e.g., a SCM) connected to a processor module (e.g., a HPM) is authorized based on multiple types of validations, including a validation of the security module using a cryptographic device identity of the security module, and another validation that includes a manifest certificate check based on a manifest certificate containing information representing a security processor in the security module. An example of the cryptographic device identity is a Device Identity (DevID) certificate, such as an Initial DevID (IDevID) certificate installed in a device (including the security module and the processor module) at the time of manufacture of the device. Another example of the cryptographic device identity is a Local DevID (LDevID) certificate generated by a customer of the device. DevIDs are explained further in Institute of Electrical and Electronics Engineers (IEEE) 802.1AR Secure Device Identity standard. An example of the manifest certificate is a platform certificate, as described by the Trusted Computing Group (TCG) Platform Certificate Profile Specification. An example of the security processor in the security module is a trusted platform module (TPM).

The multiple types of validations of the security module allow trust to be established with respect to the security module, such as in a zero-trust deployment where entities such as users, devices, and programs are not trusted implicitly or by default, but rather have to be validated each time before interactions with the entities can proceed. When a security module swap occurs, validation using the manifest certificate can allow the management system to detect that even though a security module connected to a processor module has a valid cryptographic device identity, the security module is not authorized for the processor module.

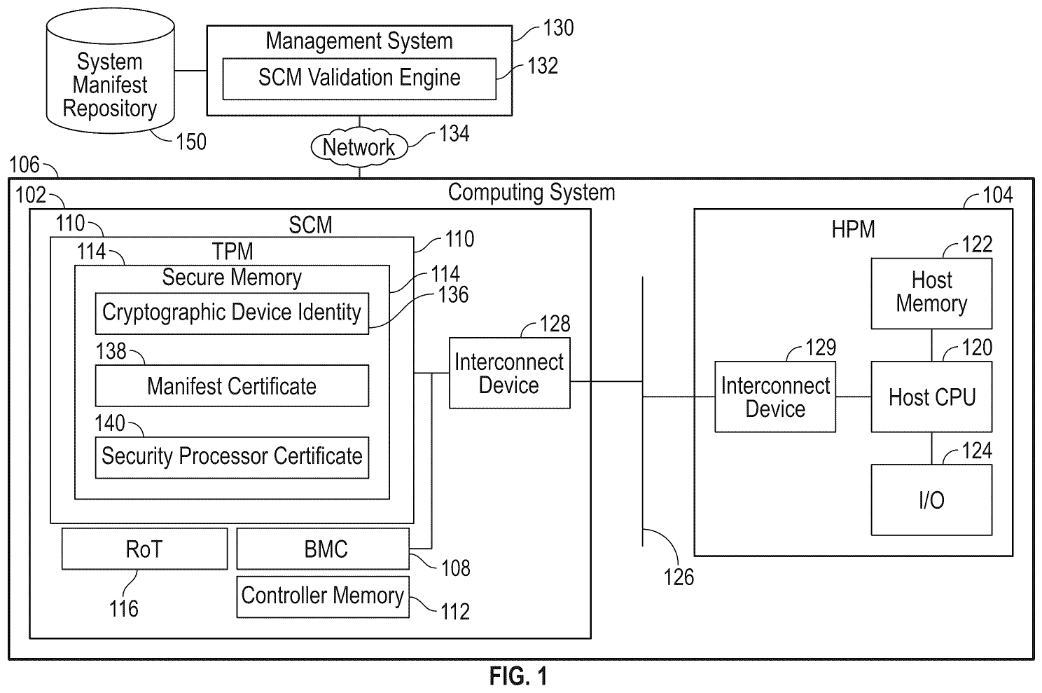

FIG. 1 is a block diagram of an example arrangement that includes a SCM 102 and a HPM 104 that are separate from one another. Some examples of the SCM 102 and the HPM 104 are depicted in FIG. 1. Note that there may be additional components or different components in other examples.

The SCM 102 and the HPM 104 can be part of computing system 106, such as any of the following: a computer (e.g., a desktop computer, a server computer, or another type of computer), a communication node (e.g., a switch, a router, a gateway, or another type of device that supports communications), a storage system, a household appliance, a vehicle, or any other type of electronic device.

In further examples, the computing system 106 may include multiple HPMs connected to respective SCMs. Due to the modular nature of the SCMs and HPMs, a SCM can be disconnected from one HPM and connected to another HPM. Similarly, a first SCM may be disconnected from a HPM and a second SCM connected to the HPM in place of the first SCM. In other examples, there may be additional computing systems each with their SCM(s) and HPM(s). In such examples, a SCM may be removed from one computing system and connected to a HPM in another computing system. Further, a HPM may be removed from a first computing system and moved into a second computing system and connected to a SCM in the second computing system.

In the various scenarios above, a SCM swap has occurred. Such a SCM swap can raise security risks.

The SCM 102 includes a management controller such as a baseboard management controller (BMC) 108. A management controller such as a BMC is responsible for performing management tasks for a processor module such as the HPM 104. The SCM 102 also includes a security processor such as a TPM 110. The security processor performs security tasks, including cryptographic operations, for the HPM 104. The TPM 110 has physical security mechanisms that protect the TPM 110 against unauthorized access, such as access by malicious programs.

The SCM 102 also includes a controller memory 112 that is accessible by the BMC 108. The controller memory 112 can be outside of or inside the BMC 108. A memory is implemented with one or more memory devices. The controller memory 112 can include nonvolatile memory that maintains data stored in the memory even if power is removed from the memory or from the computing system 106.

In accordance with some examples of the present disclosure, a management system 130 includes a SCM validation engine 132 that is used to perform multiple different types of validations of the SCM 102, to ensure that the SCM 102 is authorized to interact with the HPM 104. The management system 130 can be an external management system that is connected through a network 134 to the computing system 106. The network 134 can include the Internet, a wide area network (WAN), a local area network (LAN), or another type of network. In other examples, the management system 130 may be part of the computing system 106.

The TPM 110 in the SCM 102 includes a secure memory 114, which stores certain sensitive information that is used to perform authentication and authorization of the computing system 106. The secure memory 114 can include a nonvolatile memory. For example, the information stored in the secure memory 114 can include a cryptographic device identity 136, a manifest certificate 138, and a security processor certificate 140.

An example of the cryptographic device identity 136 is an IDevID certificate installed in the TPM 110 at the time of manufacture of the SCM 102. Another example of the cryptographic device identity 136 is a LDevID certificate generated by a customer of the computing system 106. DevIDs are explained further in the IEEE 802.1AR Secure Device Identity standard.

An IDevID certificate is an X.509 public key certificate signed by a certificate authority (CA) of a manufacturer of a device, such as the SCM 102. A “certificate” (also referred to as a “digital certificate”) refers to information (e.g., a file or another object) that is used to prove the authenticity of a user, a program, or a device. A certificate may be an X.509 certificate that is according to the X.509 Public Key Infrastructure (PKI) standard. A certificate can include information about an entity (e.g., a user, a program, or a device), and is issued by a trusted third party, such as a CA.

In some examples, the IDevID certificate includes model information (e.g., a model number that identifies the model of the SCM 102) and an identifier of the SCM 102 (such as a serial number or another type of identifier for uniquely identifying the SCM 102). The model and serial number in the IDevID are used to prove the authenticity of the SCM 102.

In other examples, a different type of cryptographic device identity can be employed, such as a device identity provided by a Device Identifier Composition Engine (DICE) specified by the TCG, where the DICE is a hardware root of trust (RoT) to protect devices or components. More generally, a cryptographic device identity includes information of a device, where the cryptographic device identity is bound to the device (such as by use of a cryptographic key) to prove an authenticity of the device.

An example of the manifest certificate 138 is a platform certificate, as described by the TCG Platform Certificate Profile Specification. A platform certificate is an X.509 attribute certificate signed by a CA of a manufacturer of a device, such as the computing system 106. The platform certificate includes a manifest of components of a system, such as components of the computing system 106 including components in the SCM 102 and the HPM 104. The components can include hardware components (e.g., the BMC 108, the TPM 110, a host central processing unit (CPU) 120, a host memory 122, or other hardware components), and/or program components (e.g., firmware and/or software). The platform certificate may be installed in the computing system 106 during the manufacture of the computing system 106, and the platform certificate is bound to the TPM 110. The platform certificate allows a recipient of the computing system 106 to confirm that a computing system shipped from a source is the computing system received by the recipient. In other examples, instead of using an industry standard manifest certificate such as the platform certificate, a proprietary manifest certificate that includes a list of components can be employed.

In other examples, the manifest certificate 138 may be stored outside the secure memory 114 of the TPM 110. For example, the manifest certificate 138 may be stored in the controller memory 112. Alternatively, the manifest certificate 138 may be stored outside the SCM 102, such as in the host memory 122 of the HPM 104 or in another memory in the computing system 106. In further examples, the manifest certificate 138 may be stored outside the computing system 106, such as in a database containing manifest certificates.

The cryptographic device identity 136 and the manifest certificate 138 can be created at different stages of manufacture of the computing system 106. The cryptographic device identity 136 can be created and stored in the TPM 110 during a manufacture stage when circuit boards (e.g., a main circuit board such as the HPM 104, the SCM 102, and other circuit boards) are integrated into the computing system 106. At this manufacture stage, the computing system 106 may be missing various components, such as the host CPU 120, the host memory 122, or other components). The manifest certificate 138 is created at a later manufacture stage, after the entire computing system 106 has been fully configured with its components. As noted above, the manifest certificate 138 includes a manifest of components of a system, which would be known after the computing system 106 is fully configured with its components including hardware components and program components.

In some cases, the manifest certificate 138 may be updated. For example, as the configuration of the computing system 106 changes due to replacement or update of components, or an addition of components, the manifest in the manifest certificate 138 can be updated to reflect the changes.

Binding a security element (such as the cryptographic device identity 136 or the manifest certificate 138 or the security processor certificate 140) to a device, such as the TPM 110 or the SCM 102, refers to associating the security element with the device so that the security element can prove the authenticity of the device.

An example of the security processor certificate 140 is an endorsement key (EK) certificate, as described by the TCG EK Credential Profile Specification. The EK certificate is used to authenticate the TPM 110. In other examples, other types of security processors can include certificates generated during the manufacture of the security processors to provide authenticity of the security processors.

The SCM 102 also includes a RoT 116, such as a hardware root of trust (HWRoT), which is also referred to as a Silicone Root of Trust (SRoT). The RoT includes a trust mechanism in the SCM 102 that is used to validate information (e.g., machine-readable instructions such as firmware and/or software to be executed on the BMC 108, configuration information, security information, and/or other information) of the SCM 102 prior to execution of the SCM 102. For example, when the computing system 106 initially starts (such as due to powering on from a lower power or off state, a reboot, a reset, etc.), the RoT 116 performs a measurement of the information of the SCM 102, and uses a value (e.g., a cryptographic hash value) produced by the measurement to perform a validation of the information of the SCM 102. The information being validated can be stored in a memory of the SCM 102, such as the controller memory 112 or a different memory in the SCM 102.

The RoT 116 can also validate information of the HPM 104. The information of the HPM 104 validated can include machine-readable instructions (e.g., firmware and/or software) to be executed on the host CPU 120 of the HPM 104, configuration information, security information, and/or other information.

The HPM 104 includes the host CPU 120, the host memory 122, and input/output (I/O) devices 124. The CPU 120 of the HPM 104 executes primary machine-readable instructions of the HPM 104. Examples of primary machine-readable instructions can include any or some combination of the following: an operating system (OS), an application program, system firmware (e.g., Basic Input/Output System (BIOS) code or Universal Extensible Firmware Interface (UEFI) code), and/or other software or firmware. The host CPU 120 can include one or more hardware processors. The primary machine-readable instructions of the HPM 104 can be stored on a storage medium of the HPM 104, such as the host memory 122 or another memory in the HPM 104.

The SCM 102 and the HPM 104 can communicate with one another over an interconnect 126. The SCM 102 includes an interconnect device 128, and the HPM 104 includes an interconnect device 129. The interconnect devices 128 and 129 are to perform communications over the interconnect 126. Each of the interconnect devices 128 and 129 is able to transmit and receive signals over the interconnect 126. The TPM 110 and the BMC 108 in the SCM 102 are able to communicate over the interconnect 126 through the interconnect device 128. The host CPU 120 of the HPM 104 is able to communicate over the interconnect 126 through the interconnect device 129. In some examples, the interconnect devices 128 and 129 can be implemented with programmable logic devices, such as complex programmable logic devices (CPLDs), programmable integrated circuits, programmable gate arrays, microcontrollers, or other types of programmable devices.

For validations of the SCM 102, the management system 130 is able to communicate with the SCM 102 over the network 134 using a secured connection. For example, communications between the management system 130 and the SCM 102 can be secured, such as by using a Mutual Transport Layer Security (mTLS) protocol that encrypts messages for security and privacy and to allow entities to authenticate one another. In other examples, other types of security protocols between the management system 130 and the SCM 102 can be employed.

In accordance with some examples of the present disclosure, the multiple types of validations performed by the SCM validation engine 132 of the management system 130 includes a first type of validation based on the cryptographic device identity 136 (e.g., IDevID certificate) stored in the secure memory 114 of the TPM 110, and a second type of validation based on the manifest certificate 138 (e.g., a platform certificate). The cryptographic device identity 136 is stored in the secure memory 114 of the TPM 110. In some examples, the manifest certificate 138 can be stored in the SCM 102, such as in the TPM's secure memory 114 or in another memory (e.g., the controller memory 112) of the SCM 102. In other examples, the manifest certificate 138 can be stored outside the SCM 102, such as in a memory (e.g., 122) of the HPM 104 or another memory of the computing system 106. The manifest certificate 138 may even be stored outside the computing system 106, such as in a database.

In some examples, the cryptographic device identity 136 and the manifest certificate 138 are signed by a CA of a manufacturer of the SCM 102. For example, the CA can sign the cryptographic device identity 136 and the manifest certificate 138 using a private key of the manufacturer.

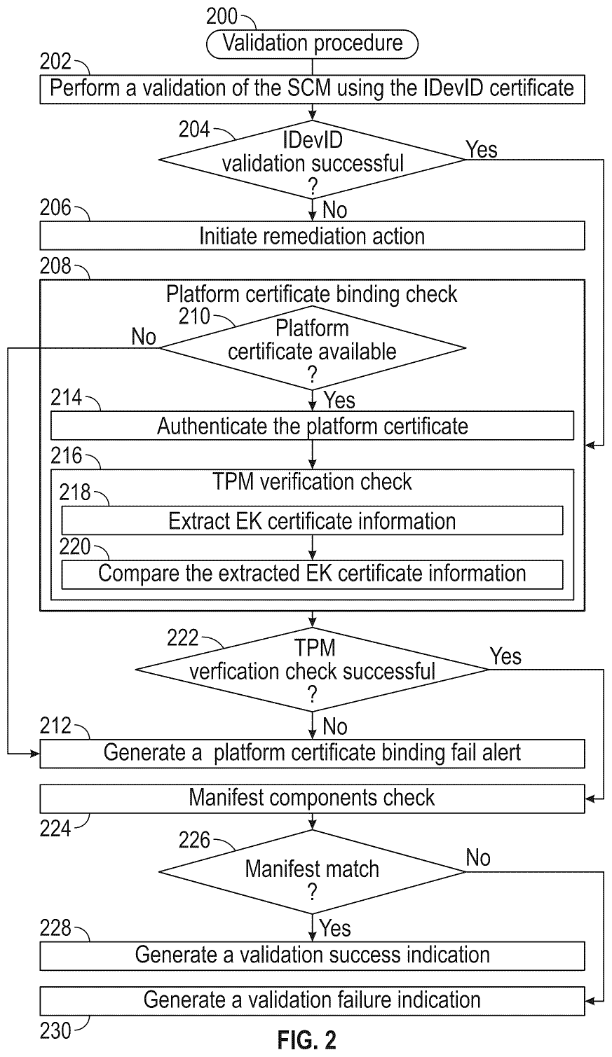

FIG. 2 is a flow diagram of a validation procedure 200 for validating a SCM connected to an HPM, such as the SCM 102 connected to the HPM 104. In some examples, the validation procedure is performed when the computing system 106 initially starts, such as from a low power state or off state, or after a reboot or reset of the computing system 106. More specifically, the validation procedure is performed after power is applied to the SCM 102 and before the SCM 102 is trusted. In some examples, the validation procedure can be performed by the SCM validation engine 132 in the management system 130.

Although FIG. 2 depicts an order of tasks, in other examples, the tasks may be performed in a different order, some tasks may be omitted, and other tasks may be added. In the discussion associated with FIG. 2, reference is made to using an IDevID certificate (an example of the cryptographic device identity 136) of the TPM 110, a platform certificate (an example of the manifest certificate 138) of the SCM 102, and an EK certificate (an example of the security processor certificate) of the TPM 110. The IDevID certificate and the EK certificate are stored in the TPM 110. The platform certificate may be stored in the SCM 102 or outside the SCM 102.

The SCM validation engine 132 performs (at 202) a validation of the SCM 102 using the IDevID certificate of the SCM 102. The IDevID certificate is an immutable certificate containing the model information and an identifier (e.g., a serial number) of the SCM 102. The validation of the SCM 102 using the IDevID certificate includes a validation handshake between the SCM validation engine 132 and the SCM 102. The validation of the SCM using the IDevID certificate includes checking that the IDevID certificate signed with an IDevID private key is valid (e.g., by using an IDevID public key) and checking that the SCM's information (e.g., the SCM's model number and the serial number) in the IDevID certificate match expected information, which may be stored in a repository of the management system 130.

The SCM validation engine 132 determines (at 204) whether the IDevID validation was successful. If not, the SCM validation engine 132 initiates (at 206) a remediation action, which can include any or some combination of the following: issue an alert of the failed validation to a target entity (e.g., a human user, a program, or a machine), disable the computing system 106 (e.g., shut down the computing system 106, disable a network interface of the computing system 106 to prevent communications with the computing system 106, shut down programs of the computing system 106), or other actions to address the failed validation.

If the SCM validation engine 132 determines (at 204) that the IDevID validation was successful, the SCM validation engine 132 proceeds to perform another validation using the platform certificate of the SCM 102. Successful validation of the IDevID certificate of the SCM 102 indicates that the SCM 102 is authentic. However, the authentic SCM 102 may not be authorized to connect to the HPM 104, such as due to a SCM swap in an identity manipulation attack.

The platform certificate validation of the SCM 102 after the IDevID validation allows the SCM validation engine 132 to detect the identity manipulation attack. The platform certificate validation of the SCM 102 effectively checks to ensure that the SCM 102 belongs to the computing system 106 in which the SCM 102 is installed.

As part of the platform certificate validation, the SCM validation engine 132 performs (at 208) a platform certificate binding check. In the platform certificate binding check, the SCM validation engine 132 determines (at 210) whether the platform certificate for the computing system 106 is available. In a first scenario, the platform certificate if available is supposed to be stored in the computing system 106, such as in the SCM 102 or in a memory of the computing system 106 outside the SCM 102. In a second scenario, the platform certificate may be stored in a designated external storage location outside the computing system 106, such as in a database accessibly by the management system 130.

For the second scenario, the SCM validation engine 132 can access the designated external storage location to retrieve the platform certificate. For the first scenario, the SCM validation engine 132 queries the SCM 102 to determine whether the platform certificate exists in the computing system 106. For example, the SCM validation engine 132 sends a platform certificate query to the SCM 102 for the platform certificate. As noted above, the platform certificate may be stored in the secure memory 114 of the TPM 110 or in another memory of the computing system 106. In response to the platform certificate query, the SCM 102 sends a platform certificate response to the SCM validation engine 132 that contains an indication of whether a platform certificate is present in the computing system 106.

If a platform certificate is not present in the computing system 106, the indication in the platform certificate response includes an error indicator (e.g., a flag set to a first value such as “0” or “1” or another value to indicate that the platform certificate is not present in the computing system 106). If the platform certificate is supposed to be stored in the SCM 102, the platform certificate may be absent from the SCM 102 if the SCM 102 is a repair SCM, which is used to replace a prior SCM connected to the HPM 104 due to the prior SCM exhibiting a fault. Because the repair SCM is provided after the manufacture of the computing system 106, the repair SCM would not be provisioned with a platform certificate for the computing system 106. The platform certificate may be missing for other reasons, such as due to a fault of the SCM 102 or the computing system 106 resulting in the platform certificate no longer being accessible.

If the platform certificate is present (either in the SCM 102 or outside the SCM 102 in the computing system 106), the platform certificate response from the SCM 102 includes the platform certificate.

If the SCM validation engine 132 determines (at 210) that the platform certificate for the computing system 106 is not available, the SCM validation engine 132 generates (at 212) a platform certificate binding fail alert. The platform certificate binding fail alert can be sent to a target entity. The alert can be in the form of a message, an information element, or any other type of indicator. In response to the platform certificate binding fail alert, the management system 130 or the target entity can take a remediation action according to a policy to address the absence of the platform certificate. The remediation action can be similar to the remediation action taken in response to a failed IDevID validation as discussed further above.

Further, in response to the platform certificate binding fail alert, an administrator or another user can perform an investigation to determine whether the SCM 102 is authorized to be used with the HPM 104 despite the SCM swap. For example, the SCM swap may be due to maintenance or repair activities.

The SCM validation engine 132 can determine (at 210) that the platform certificate for the computing system 106 is not available based on receiving the platform certificate response with the error indicator from the SCM 102 in the second scenario where the platform certificate is supposed to be in the computing system 106. Alternatively, in the first scenario, the SCM validation engine 132 can determine (at 210) that the platform certificate for the computing system 106 is not available based on not being able to successfully retrieve the platform certificate from the designated external storage location.

If the SCM validation engine 132 determines (at 210) that the platform certificate for the computing system 106 is available, the SCM validation engine 132 can authenticate (at 214) the signed platform certificate (as signed by the manufacturer's CA). The SCM validation engine 132 can authenticate the signed platform certificate by using a public key to determine whether the platform certificate can be successfully derived from the signed platform certificate. If so, then the platform certificate is authenticated.

The SCM validation engine 132 further performs (at 214) a TPM verification check to confirm that the platform certificate refers to the TPM to which the IDevID is bound. The TPM verification check includes obtaining (at 216), from the platform certificate, a reference to the EK certificate in the TPM 110 of the SCM 102. The reference includes information identifying the EK certificate. The TPM verification check includes extracting (at 218) information from the EK certificate, where the extracted information can include a TPM manufacturer identifier and the TPM's EK (endorsement key)from the EK certificate, and comparing (at 220) the extracted TPM manufacturer identifier and the TPM's EK to the TPM manufacturer identifier and the TPM's EK in the platform certificate. The EK is unique to the TPM 110 and the EK identifies the TPM 110. Alternatively, the TPM verification check includes computing a digest of the EK certificate and comparing the digest to a stored digest. The digest of the EK certificate can include a cryptographic hash value generated based on applying a cryptographic hash function to information in the EK certificate.

Based on the comparison (at 220), the SCM validation engine 132 determines (at 222) whether the TPM verification check was successful. If the comparison (at 220) produces a match, the TPM verification check was successful and the platform certificate binding has passed.

However, if the comparison (at 220) does not produce a match, the TPM verification check was unsuccessful and the platform certificate binding fails. The mismatch may occur if the platform certificate is outside the SCM 102 and a SCM swap occurred, since the platform certificate outside the SCM 102 would refer to an EK certificate that is different from the EK certificate in the TPM 110 of the SCM 102.

If the SCM validation engine 132 determines (at 222) that the TPM verification check was not successful, which means that the platform certificate binding has failed, the SCM validation engine 132 generates (at 212) the platform certificate binding fail alert, which can trigger a remediation action and an investigation to determine whether the SCM 102 is authorized to be used with the HPM 104.

If the SCM validation engine 132 determines (at 222) that the TPM verification check was successful, which means that the platform certificate binding has passed, the SCM validation engine 132 performs (at 224) a manifest components check using the manifest in the platform certificate. The manifest components check includes comparing identifiers (e.g., hardware serial numbers or other identifiers) of hardware components (e.g., the host CPU 120, the host memory 122, an I/O device 124, a power supply, a bridge chip, or any other hardware component) and/or program components (e.g., a host OS, a system firmware, or other programs) in the manifest of the platform certificate to a collection of identifiers stored in a system manifest repository 150 (e.g., a database) accessible by the SCM validation engine 132. The collection of identifiers in the system manifest repository 150 identify components that are supposed to be in the computing system 106. The collection of identifiers may have been added to the system manifest repository 150 by the manufacturer of the computing system 106.

The SCM validation engine 132 determines (at 226) whether the comparison of the manifest components check produces a match. If the comparison of the manifest components check produces the match, then the SCM 102 is the correct SCM for the computing system 106, and the SCM validation engine 132 generates (at 228) a validation success indication. The validation success indication can be in the form of a message, an information element, or another indicator that may be sent to a target entity. At this point, the computing system 106 is allowed to continue with its normal operations.

If the comparison of the manifest components check produces a mismatch, then the SCM 102 is not the correct SCM for the computing system 106, and the SCM validation engine 132 generates (at 230) a validation failure indication, which can trigger a remediation action and an investigation to determine whether the SCM 102 is authorized to be used with the HPM 104 despite the SCM swap.

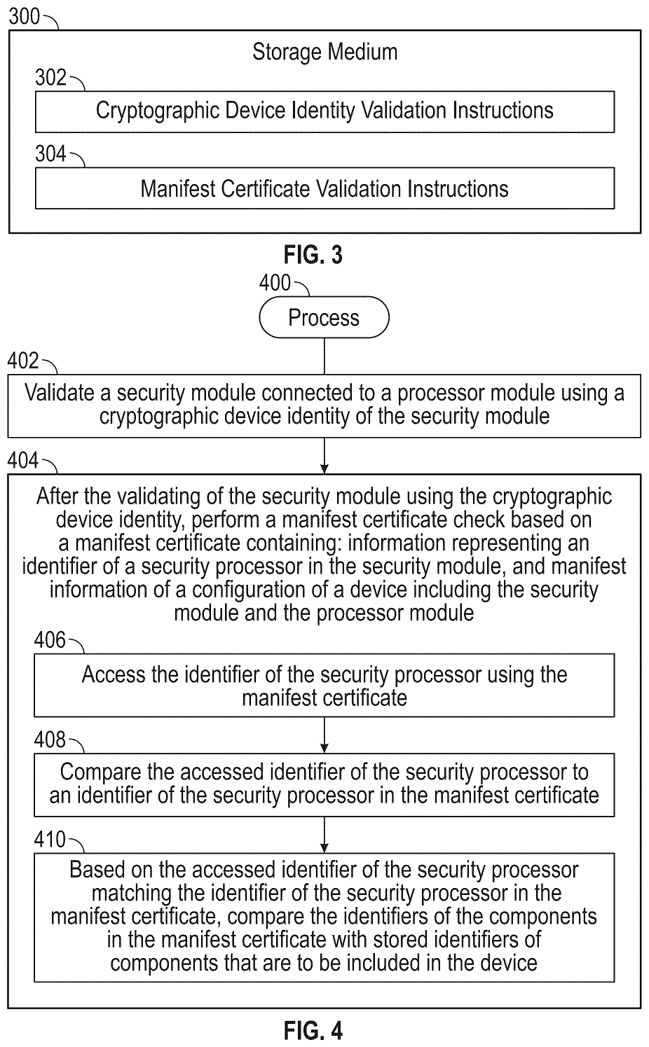

FIG. 3 is a block diagram of a non-transitory machine-readable or computer-readable storage medium storing machine-readable instructions that upon execution cause a system to perform various tasks. An example of the system is the management system 130 of FIG. 1, for example. Machine-readable instructions may include the instructions of the SCM validation engine 132, for example.

The machine-readable instructions include cryptographic device identity validation instructions 302 to validate a security module (e.g., the SCM 102 of FIG. 1) connected to a processor module (e.g., the HPM 104 of FIG. 1) using a cryptographic identity of the security module. The cryptographic device identity can include a DevID certificate, such as an IDevID certificate or a LDevID certificate, for example.

The machine-readable instructions include manifest certificate validation instructions 304 to perform a manifest certificate check based on a manifest certificate (e.g., a platform certificate) containing information representing a security processor in the security module. The manifest certificate can also include information of components in a device (e.g., the computing system 106) that includes the security module and the processor module.

In some examples, the information representing the security processor in the security module includes a reference to a security processor certificate (e.g., an EK certificate) that is bound to the security processor (e.g., a TPM) in the security module.

In some examples, the manifest certificate check includes obtaining an identifier of the security processor using the security processor certificate, and comparing the obtained identifier of the security processor to an identifier of the security processor in the manifest certificate. The machine-readable instructions can generate a failure indication (e.g., the platform certificate binding fail alert in FIG. 2) in response to the obtained identifier of the security processor not matching the identifier of the security processor in the manifest certificate. The failure indication indicates that the security module is potentially not authorized for the processor module.

In some examples, the identifier of the security processor includes an EK of the security processor.

In some examples, the failure indication is to trigger a check of whether use of the security module with the processor module is part of an authorized action, such as a maintenance or repair action.

In some examples, the manifest certificate further contains manifest information for a configuration of a device including the security module and the processor module, and the manifest information includes identifiers of components of the device, such as identifiers of hardware components and program components. The hardware components can be part of the security module and the processor module.

In some examples, the manifest certificate check further includes comparing the identifiers of the components in the manifest certificate with stored identifiers of components that are to be included in the device.

In some examples, the machine-readable instructions generate a failure indication (e.g., the validation failure indication of FIG. 2) in response to the identifiers of the electronic components in the manifest certificate not matching the stored identifiers, the failure indication indicating that the security module is potentially not authorized for the processor module.

In some examples, the manifest certificate check further includes deriving information based on a security processor certificate of the security processor, and determining based on the derived information whether the manifest certificate refers to the security processor to which the cryptographic device identity is bound. The machine-readable instructions can compare the identifiers of the components in the manifest certificate with the stored identifiers responsive to determining that the manifest certificate refers to the security processor to which the cryptographic device identity is bound.

In some examples, the security processor certificate includes an EK certificate, and the derived information includes an EK or a digest based on the EK certificate.

In some examples, the manifest certificate check includes determining whether the manifest certificate is stored in the security module, where the manifest certificate check produces a failure indication if the manifest certificate is not stored in the security module, the failure indication indicating that the security module is potentially not authorized for the processor module.

FIG. 4 is a flow diagram of a process 400 according to some examples. The process 400 may be performed by the SCM validation engine 132 in the management system 130 of FIG. 1, for example.

The process 400 includes validating (at 402) a security module connected to a processor module using a cryptographic device identity of the security module. This validation can include performing a handshake to validate the security module using a DevID certificate, for example.

The process 400 includes, after the validating of the security module using the cryptographic device identity, performing (at 404) a manifest certificate check based on a manifest certificate containing: information representing an identifier of a security processor in the security module, and manifest information of a configuration of a device including the security module and the processor module. The information representing the identifier of the security processor in the manifest certificate can include a reference to a security processor certificate (e.g., an EK certificate) bound to the security processor. The manifest information includes identifiers of components of the device.

The manifest certificate check includes accessing (at 406) the identifier of the security processor using the manifest certificate, comparing (at 408) the accessed identifier of the security processor to an identifier of the security processor in the manifest certificate, and based on the accessed identifier of the security processor matching the identifier of the security processor in the manifest certificate, comparing (at 410) the identifiers of the components in the manifest certificate with stored identifiers of electronic components that are to be included in the device.

In some examples, the accessing of the identifier of the security processor using the manifest certificate includes using the reference in the manifest certificate to retrieve the security processor certificate, and obtaining the identifier of the security processor from the security processor certificate. The identifier of the security processor includes an EK of the security processor.

In some examples, process 400 generates a failure indication in response to either (1) the accessed identifier of the security processor not matching the identifier of the security processor in the manifest certificate, or (2) the identifiers of the electronic components in the manifest certificate not matching the stored identifiers. The failure indication indicates that the security module is potentially not authorized for the processor module.

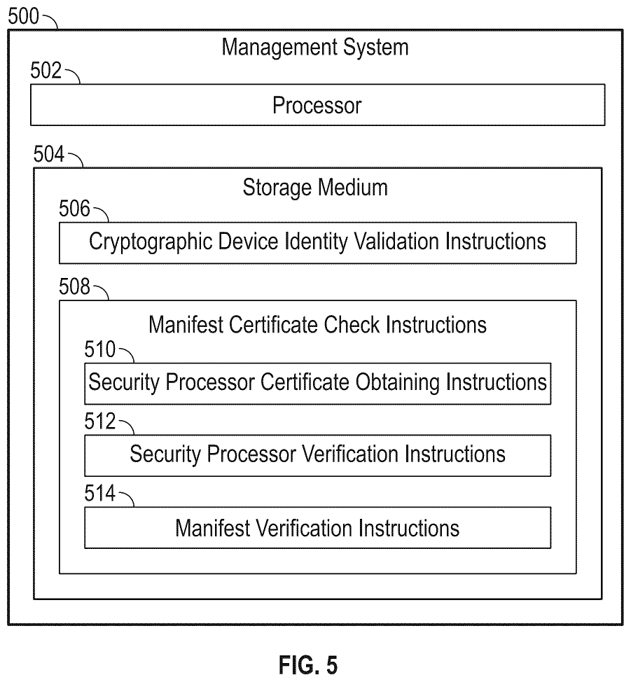

FIG. 5 is a block diagram of a management system 500, such as the management system 130 of FIG. 1. The management system 500 includes a hardware processor 502 (or multiple hardware processors). A hardware processor can include a microprocessor, a core of a multi-core microprocessor, a microcontroller, a programmable integrated circuit, a programmable gate array, or another hardware processing circuit.

The management system 500 further includes a storage medium 504 storing machine-readable instructions executable on the hardware processor 502 to perform various tasks. Machine-readable instructions executable on a hardware processor can refer to the instructions executable on a single hardware processor or the instructions executable on multiple hardware processors.

The machine-readable instructions in the storage medium 504 include cryptographic device identity validation instructions 506 to validate a security module (including a security processor) connected to a processor module using a cryptographic device identity of the security module.

The machine-readable instructions in the storage medium 504 include manifest certificate check instructions 508 to perform a manifest certificate check based on information in a manifest certificate. The manifest certificate check instructions 508 include security processor certificate obtaining instructions 510 to obtain a security processor certificate using a reference in the manifest certificate, security processor verification instructions 512 to determine based on information derived from the security processor certificate whether the manifest certificate refers to the security processor to which the cryptographic device identity is bound, and manifest verification instructions 514 to compare identifiers of components in the manifest certificate to stored identifiers.

A memory device of a memory can be implemented using a nonvolatile memory device such as a flash memory device or another type of nonvolatile memory device. The memory may also include one or more volatile memory devices, such as a dynamic random access memory (DRAM) device, a static random access memory (SRAM) device, and so forth.

A “BMC” (e.g., 108 in FIG. 1) can refer to a specialized service controller that monitors the physical state of a computing system using sensors and communicates with a remote management system (that is remote from the computing system) through an independent “out-of-band” connection. The BMC can perform management tasks to manage components of the computing system. Examples of management tasks that can be performed by the BMC can include any or some combination of the following: power control to perform power management of the computing system (such as to transition the computing system between different power consumption states in response to detected events), thermal monitoring and control of the computing system (such as to monitor temperatures of the computing system and to control thermal management states of the computing system), fan control of fans in the computing system, system health monitoring based on monitoring measurement data from various sensors of the computing system, remote access of the computing system (to access the computing system over a network, for example), remote reboot of the computing system (to trigger the computing system to reboot using a remote command), system setup and deployment of the computing system, system security to implement security procedures in the computing system, and so forth.

In some examples, the BMC can provide so-called “lights-out” functionality for a computing system. The lights out functionality may allow a user, such as a systems administrator, to perform management operations on the computing system even if an OS is not installed or not functional on the computing system.

Moreover, in some examples, the BMC can run on auxiliary power provided by an auxiliary power supply (e.g., a battery); as a result, the computing system does not have to be powered on to allow the BMC to perform the BMC's operations. The auxiliary power supply is separate from a main power supply that supplies powers to other components (e.g., a main processor, a memory, an input/output (I/O) device, etc.) of the computing system.

As used here, an “engine” (e.g., the SCM validation engine 132 of FIG. 1) can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

A storage medium (e.g., 300 in FIG. 3 or 504 in FIG. 5) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
validate a security module connected to a processor module using a cryptographic device identity of the security module; and
perform a manifest certificate check based on a manifest certificate containing information representing a security processor in the security module.

2. The non-transitory machine-readable storage medium of claim 1, wherein the information representing the security processor in the security module comprises a reference to a security processor certificate that is bound to the security processor in the security module.

3. The non-transitory machine-readable storage medium of claim 2, wherein the security processor certificate comprises an endorsement key (EK) certificate, and the security processor comprises a trusted platform module (TPM).

4. The non-transitory machine-readable storage medium of claim 2, wherein the manifest certificate check comprises obtaining an identifier of the security processor using the security processor certificate, and comparing the obtained identifier of the security processor to an identifier of the security processor in the manifest certificate, and wherein the instructions upon execution cause the system to:
generate a failure indication in response to the obtained identifier of the security processor not matching the identifier of the security processor in the manifest certificate, the failure indication indicating that the security module is potentially not authorized for the processor module.

5. The non-transitory machine-readable storage medium of claim 4, wherein the failure indication is to trigger a check of whether use of the security module with the processor module is part of an authorized action.

6. The non-transitory machine-readable storage medium of claim 4, wherein the identifier of the security processor comprises an EK of the security processor.

7. The non-transitory machine-readable storage medium of claim 1, wherein the manifest certificate further contains manifest information for a configuration of a device comprising the security module and the processor module, and wherein the manifest information comprises identifiers of components of the device.

8. The non-transitory machine-readable storage medium of claim 7, wherein the identifiers in the manifest information of the manifest certificate comprises an identifier of a hardware component in the processor module.

9. The non-transitory machine-readable storage medium of claim 7, wherein the manifest certificate comprises a platform certificate provided by a manufacturer of the device.

10. The non-transitory machine-readable storage medium of claim 7, wherein the manifest certificate check comprises comparing the identifiers of the components in the manifest certificate with stored identifiers of components that are to be included in the device.

11. The non-transitory machine-readable storage medium of claim 10, wherein the instructions upon execution cause the system to:
generate a failure indication in response to the identifiers of the components in the manifest certificate not matching the stored identifiers, the failure indication indicating that the security module is potentially not authorized for the processor module.

12. The non-transitory machine-readable storage medium of claim 10, wherein the manifest certificate check further comprises deriving information based on a security processor certificate of the security processor, and determining based on the derived information whether the manifest certificate refers to the security processor to which the cryptographic device identity is bound, and wherein the instructions upon execution cause the system to:
compare the identifiers of the components in the manifest certificate with the stored identifiers responsive to determining that the manifest certificate refers to the security processor to which the cryptographic device identity is bound.

13. The non-transitory machine-readable storage medium of claim 12, wherein the security processor certificate comprises an endorsement key (EK) certificate, and the derived information comprises an EK or a digest based on the EK certificate.

14. The non-transitory machine-readable storage medium of claim 1, wherein the manifest certificate check comprises determining whether the manifest certificate is stored in the security module, wherein the manifest certificate check produces a failure indication if the manifest certificate is not stored in the security module, the failure indication indicating that the security module is potentially not authorized for the processor module.

15. The non-transitory machine-readable storage medium of claim 1, wherein the cryptographic device identity comprises a device identity (DevID) certificate.

16. A method comprising:
validating, by a management system comprising a hardware processor, a security module connected to a processor module using a cryptographic device identity of the security module; and
after the validating, performing, by the management system, a manifest certificate check based on a manifest certificate containing:
information representing an identifier of a security processor in the security module, and
manifest information of a configuration of a device comprising the security module and the processor module, the manifest information comprising identifiers of components of the device,
wherein the manifest certificate check comprises:
accessing the identifier of the security processor using the manifest certificate,
comparing the accessed identifier of the security processor to an identifier of the security processor in the manifest certificate, and
based on the accessed identifier of the security processor matching the identifier of the security processor in the manifest certificate, comparing the identifiers of the components in the manifest certificate with stored identifiers of components that are to be included in the device.

17. The method of claim 16, wherein the accessing of the identifier of the security processor using the manifest certificate comprises using a reference in the manifest certificate to retrieve a security processor certificate, and obtaining the identifier of the security processor from the security processor certificate, and wherein the identifier of the security processor comprises an endorsement key (EK) of the security processor.

18. The method of claim 16, comprising:
generating, by the management system, a failure indication in response to:
the accessed identifier of the security processor not matching the identifier of the security processor in the manifest certificate, or
the identifiers of the components in the manifest certificate not matching the stored identifiers,
wherein the failure indication indicates that the security module is potentially not authorized for the processor module.

19. A management system comprising:
a processor; and
a non-transitory storage medium comprising instructions executable on the processor to:
validate a security module comprising a security processor and connected to a processor module using a cryptographic device identity of the security module; and
perform a manifest certificate check based on information in a manifest certificate, the manifest certificate check comprising:
obtaining a security processor certificate using a reference in the manifest certificate,
determining based on information derived from the security processor certificate whether the manifest certificate refers to the security processor to which the cryptographic device identity is bound, and
comparing identifiers of components in the manifest certificate to stored identifiers.

20. The management system of claim 19, wherein the cryptographic device identity comprises a Device Identity (DevID) certificate, the manifest certificate comprises a platform certificate, and the security processor certificate comprises an endorsement key (EK) certificate.
